(19) United States
(12) Patent Application Publication
(10) Pub. No.: US 2025/0215254 A1
(43) Pub. Date: Jul. 3, 2025

(54) Extruded Ballast Protection for Waterproofing

(71) Applicant: GCP Applied Technologies Inc., Malvern, PA (US)

(72) Inventors: Abbas Kazmi, Manchester (GB); Jonathon Millner, High Peak (GB); Thomas Carter, Stonington, CT (US); Greg Laugeni, Woodbridge, CT (US); Xia Cao, Acton, MA (US)

(21) Appl. No.: 18/852,304

(22) PCT Filed: Mar. 30, 2023
(86) PCT No.: PCT/US2023/016982

§ 371 Date: Sep. 27, 2024

Related U.S. Application Data
(60) Provisional application No. 63/325,399, filed on Mar. 30, 2022.

(51) Int. Cl. C09D 133/12; C09D 4/00; C09D 7/40; C09D 7/60; E01B 27/02; E01D 19/08

(52) U.S. Cl. CPC C09D 133/12; C09D 4/00; C09D 7/60; C09D 7/69; E01B 27/02; E01B 2203/062; E01D 19/083

(57) ABSTRACT

A method for establishing ballast protection film over a waterproofing membrane, the method comprising: a. providing at least one layer of a waterproofing membrane on a surface to form a waterproof seal upon said surface; and b. applying onto a surface of the waterproofing membrane a liquid curable composition at an average uncured thickness of no less than 0.5 mm and no greater than 50 mm, wherein the liquid curable composition comprises (i) at least one reactive acrylate-based monomer, and (ii) a polymerization initiator added to activate polymerization of the reactive acrylate-based monomer, wherein the liquid curable composition cures and forms a resin film when applied to the surface of the waterproofing membrane.

### TECHNICAL FIELD

The present disclosure relates generally to the field of waterproofing and ballast protection for railroad and bridge deck applications, and more particularly to a novel method and system wherein protection members or units are extruded over waterproofing membranes to provide protection against ballast material placed over the membranes as typically done in railway applications.

### BACKGROUND

Track ballast, typically made of gravel and rocks, is used in railway structures to provide a stable substrate upon which to place railway ties and tracks. One example of a prior art system for waterproofing and supporting a railway ballast involves the use of a primer, waterproofing membrane, and a ballast mat for protecting the waterproofing membrane against punctures from overlying ballast material.

Conventional ballast mats can include fabrics such as fleeces or geotextiles, bituminous protection boards, reactive composition membranes, and rubber-particles contained between or within the coatings. By themselves, fabrics offer little protection to the membrane against forces sufficient to displace or cause indentations. Highly undesirable conditions can arise due to penetration by water or corrosive chemicals through the fabrics due to water pooling on top of the waterproofing membrane.

For several decades, spray-application of quick gelling waterproofing membranes was used in railway and highway bridge deck systems using resin compositions available under the ELIMINATOR® brand from Stirling Lloyd, a subsidiary of the assignee hereof. Over the membrane, a ballast protection course was spray applied using successive spray coatings to build up a thick ballast protection coating, and a ballast mat was also typically used.

Spray coating of wet film compositions requires numerous successive spray passes to establish a railway ballast protection coating, and this technique is described in the patent literature. See e.g., U.S. Pat. Nos. 9,441,335, 9,869,065, 10,132,049, 10,415,197, 10,612,198, and CA 2832030.

For example, in U.S. Pat. No. 9,441,335 to Haydu describes an example method for establishing ballast protection coatings that involves spray applying coatings in successive manner “as a series of layers of resin, then filler, then resin, etc.” See e.g., col. 5, lines 42-47. The compounds and filler can be rubber based. As illustrated in FIG. 3 and described at col. 4, lines 57 to col. 5, line 10 of Haydu, it is explained that the ballast protection coating could be applied to irregular or uneven surfaces at varying thicknesses to form level or uniformly sloped surfaces, including an “isosceles triangle cross-sectional profile” (see col. 6, lines 33-34). The rubber-containing coating system of Haydu also employed a ballast mat and sealing layer (See Abstract).

Prior art spray-applied ballast protection coatings, in addition to being time-consuming, required further steps to address other deficiencies. For example, protection boards needed to be used for additional mechanical protection over the spray-applied coatings. Protection boards such as bituminous or asphaltic sheets were sometimes used, but these are rigid and posed tripping hazards for workers. To provide compressibility, rubber particles and/or rubber filler in the coatings need to be used, and the use of rubber particles between the spray coatings was both labor intensive and time-consuming.

Accordingly, there is a need in the art to overcome the issues associated with conventional ballast protection coating technologies such as poor ballast indentation resistance, uneven surfacing, inefficient spray application challenges, poor skid resistance, and other disadvantages.

### SUMMARY

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein, although it will be shown that the novel nature of the present invention can resolve many of these problems rather handily.

According to one aspect, disclosed is a method for establishing ballast protection film over a waterproofing membrane, the method comprising: a. providing at least one layer of a waterproofing membrane on a surface to form a waterproof seal upon said surface; and b. applying onto a surface of the waterproofing membrane a liquid curable composition at an average uncured thickness of at least about 0.5 mm, wherein the liquid curable composition comprises (i) at least one reactive acrylate-based monomer, and (ii) a polymerization initiator added to activate polymerization of the reactive acrylate-based monomer, wherein the liquid curable composition cures and forms a resin film when applied to the surface of the waterproofing membrane.

According to another aspect of the disclosure, disclosed is a method for establishing ballast protection film over a waterproofing membrane, the method comprising: a. providing at least one layer of a waterproofing membrane on a surface to form a waterproof seal upon said surface: b. mixing together at least two components, wherein one component comprises at least one reactive (meth)acrylate-based monomer and the other component comprises at least one polymerization initiator to activate polymerization of the reactive (meth)acrylate-based monomer and to form a liquid curable composition; and c. applying onto a surface of the waterproofing membrane the liquid curable composition at an average uncured thickness of at least about 0.5 mm, wherein the liquid curable composition comprises (i) from about 1 to about 20 wt. % of at least one reactive (meth)acrylate-based monomer; (ii) from about 1.0 to about 10 wt. % of a polymerization initiator added to activate polymerization of the reactive (meth)acrylate-based monomer, wherein the liquid curable composition cures and forms a resin film when applied to the surface of the waterproofing membrane: and (iii) from about 55 wt. % to about 80 wt. % of inorganic particles.

### DETAILED DESCRIPTION OF ILLUSTRATIVE EMBODIMENTS

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions with respect to the present invention; or is known to be relevant to an attempt to solve any problem with which this specification is concerned.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. Certain features of the disclosure which are described herein in the context of separate embodiments may also be provided in combination in a single embodiment. Conversely, various features of the disclosure that are described in the context of a single embodiment may also be provided separately or in any subcombination.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5%. 50%, 51%, 52% . . . 95%, 96%, 97%, 98%, 99%, or 100%. Moreover, any numerical range represented by any two values of R, as calculated above, is also specifically disclosed.

Liquid curable compositions disclosed herein form a slurry that has desirable slump properties while curing and desirable characteristics when applied on a deck and fully cured and having a rough and durable surface texture. These performance characteristics are ideal for a coating that needs to withstand traffic and other stresses. Furthermore, the ballast protection films disclosed herein exhibit excellent shear and tensile adhesion to a waterproof membrane. It was found that the viscosity of the compositions allows easy and fast application on a large area using a large screed bar, a mechanical pump for extrusion or spray application. Once cured, the compositions provides ample surface texture and have excellent anti-skid properties. Depending on how the compositions are applied while curing, they can form a flat or stepped shape. For example, using a screed bar that is flat will result in a flat, textured surface of the ballast protection film. Multiple longitudinal applications of a flat application at various thicknesses can also form a stepped pattern. Furthermore, it is not essential to use a screed bar in a scenario where a mold section is just filled with slurry to the mold height without any screeding. A pin rake can be used to spread out resin on the deck with or without a mold at the desired thickness.

Disclosed is a method for establishing ballast protection film over a waterproofing membrane, the method comprising: a. providing at least one layer of a waterproofing membrane on a surface to form a waterproof seal upon said surface; and b. applying onto a surface of the waterproofing membrane a liquid curable composition at an average uncured thickness of no less than 0.5 mm and no greater than 50 mm, wherein the liquid curable composition comprises (i) at least one reactive acrylate-based monomer, and (ii) a polymerization initiator added to activate polymerization of the reactive acrylate-based monomer, wherein the liquid curable composition cures and forms a resin film when applied to the surface of the waterproofing membrane.

The first step of the method comprises providing at least one layer of a waterproof membrane comprising a surface to form a waterproof seal upon said surface. The surface could be a substrate and the substrate could include additional layers upon which the at least one layer of a waterproof membrane can be applied. Substrates include, for example, concrete, steel, wood, or plastic decking. Additional layers can include, for example, additional membrane and/or primer layers (e.g., methacrylate adhesive layer, epoxy layer) that may be spray-coated or applied as sheets of material. For purposes of this step, the term “substrate” upon which the waterproof membrane is applied includes the substrate and any additional layers or materials on the substrate and upon which the waterproof membrane is applied. The waterproof membrane is preferably elastic and can be made from commercially available spray-able resin types, e.g., such as sold under the Eliminator® brand from Stirling Lloyd, Great Britain. The membrane is preferably installed after application of a primer coating upon a concrete deck or upon a steel substrate.

Substrates or substrate systems can include, for example, the support system under a railroad track and supporting ballast such as, for example, a railway bed, such as packed earth, concrete, asphalt, concrete and steel rail bridge structures, tunnels, and other structures. In other embodiments, a railway system can include a railroad, light rail, subway systems, and elevated rail structures. Typically, there is a railway protection system disposed between the railway bed and the ballast. Thus, in some embodiments, the substrate is a railway protection system that includes a waterproof membrane and an integrated ballast mat.

The waterproof membrane can be applied along any length of the railway bed. The waterproof membrane can be uniformly applied over irregular surfaces and can be applied horizontally, vertically and overhead. The thickness of each the layer of waterproof membrane can be between 10 and 150 mils thick and can be between 60 and 120 mils thick. In one embodiment, the waterproof membrane can be 80 mils thick. In some embodiments one or more layers of the waterproof membrane can be applied on top of each other. In one embodiment a first layer of the waterproof membrane is 40 mils thick and a second layer of the membrane is 40 mils thick. The waterproof membrane can be applied so that it has a substantially uniform thickness. In some embodiments the waterproof membrane can be applied having varying thicknesses. The term “mil” and “mils” are a unit of measurement that refers to a thousandth of an inch. For example, 20 mils refers to 20 thousandths of an inch.

The waterproof membrane can cover all or part of railway bed. For example, on a bridge, the waterproof membrane can cover the entire surface of the bridge deck. In some instances, the waterproof membrane will extend out to a predetermined position or location, such as a drainage area. Preferably, the waterproof membrane defines a fluid tight seal on the surface of the railway bed. Preferably, the waterproof membrane can cover the railway bed without seams, which can reduce weak points in the fluid tight seal.

In some embodiments where an adhesive or primer layer is installed, the adhesive layer can be a primer application and can be applied prior to the placement of the waterproof membrane. The adhesive layer can be the same material as all or part of the waterproof membrane. The adhesive layer can be applied by spraying or rolling the material while it is in a substantially fluid state. In some embodiments the adhesive layer can be between 2 mils and 10 mils thick.

The second step in the method comprises applying directly onto a surface of the waterproof membrane a liquid curable composition at an average uncured thickness of at least about 0.5 mm, wherein the liquid curable composition comprises (i) at least one reactive (meth)acrylate-based monomer, and (ii) a polymerization initiator added to activate polymerization of the reactive (meth)acrylate-based monomer, wherein the liquid curable composition cures and forms a resin film when applied to the surface of the waterproof membrane. As will be described below, the liquid curable composition will need to be mixed prior to the applying step and, therefore, the method of the present invention includes the step of mixing together at least a first component and a second component, wherein liquid composition is activated to polymerize upon the mixing of the components.

In preferred embodiments, the liquid curable composition is applied as a single layer on top of the waterproof membrane such that, when cured, a single layer ballast protection film is formed.

The liquid curable composition comprises as one component at least one reactive (meth)acrylate-based monomer. As used herein, the term “reactive (meth)acrylate-based monomer” is inclusive of both acrylate and methacrylate functionality. As intended herein, a “resin” means a composition that has been polymerized or cured or crosslinked. The reactive acrylate-based monomer may be an alky (meth)acrylate, which may be an alkyl (meth)acrylate whose alkyl group has 1 to 20 carbon atoms. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, etc. These can be used singly as one species or in a combination of two or more species.

In certain embodiments, the at least one reactive (meth)acrylate-based monomer is methyl methacrylate, n-butyl methacrylate, 2-ethyl hexyl acrylate, and mixtures thereof.

The at least one reactive (meth)acrylate-based monomer can be present in the composition once mixed at from about 5 wt. % to about 30 wt. %, preferably from about 10 wt. % to about 20 wt. %, and more preferably from about 12 wt. % to about 15 wt. %.

The composition also comprises a polymerization initiator added to activate polymerization of the reactive acrylate-based monomer. In embodiments, the polymerization initiator is an organic peroxide and functions to initiate free-radical polymerization of the (meth)acrylate monomer. Organic peroxides can be divided into diacylperoxides, hydroperoxides, dialkylperoxides, peroxyesters, peroxyketals and peroxy(di)carbonates, all of which are well known to those skilled in the art. Examples of free-radical polymerization initiators include, for example, dicumyl peroxide, tert-butyl peroxybenzoate, dibenzoyl peroxide (BPO), 2,5-dimethyl-2,5-di(tert-butylperoxy)-3-hexyne (25B), bis(tert-butylperoxyisopropyl)benzene, and combinations thereof. A preferred organic peroxide is dibenzoyl peroxide (BPO). The amount of initiator is preferably from about 0.50 wt. % to about 20 wt. % based on the weight of the composition to be applied. Because the initiator initiates polymerization of the monomer, it is kept separate from the at least one reactive (meth)acrylate-based monomer until just prior to mixing for the applying step and thus constitutes the at least one second component. The polymerization initiator can be added as a powder or a suspension.

As an optional component, the composition may comprise a polymerization or curing accelerator. Preferred examples thereof include, but are not limited to, amines such as diisopropyl toluidine, dimethyl propyl toluidine, trimethylamine, methyl hydroxy propyl toluidine, methyldimethanolamine, triethanolamine, p-diethylaminoacetophenone, p-dimethylaminoethylbenzoate, p-dimethylaminobenzoate-2-ethylhexyl, N,N-dimthylbenzylamine and 4,4′-bis(diethylamino)benzophenone. In one embodiment, the polymerization accelerator is selected from the group consisting of dimethyl propyl toluidine, diisopropyl toluidine, and methyl hydroxy propyl toluidine. The curing accelerator may be with the at least one second component. The amount of curing accelerator, if present, is preferably from about 0.01 wt. % to about 1.5 wt. % and preferably 0.5% wt.% based on the weight of the composition to be applied.

Another optional component is a methacrylate-based polymer such as, for example, polymethyl methacrylate and polyurethane acrylate polymer. Such polymers function to improve physical properties and curing times and, when used, are present at from 0.5 wt. % to 20 wt. %, preferably, from 1.0 wt. % to 15 wt. %.

Another optional but preferred component of the liquid curable composition is inorganic filler particles. The inorganic filler particles function to provide additional strength and treadability and skid resistance to the ballast protection film. Examples of the inorganic filler include but are not limited to silica (fumed, non-fumed, porous or hollow type), silicon oxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOOH), calcined talc, talc, silicon nitride, stone, aggregate, and calcined kaolin. In one embodiment, the inorganic particles is selected from the group consisting of calcium carbonate, silicon oxide, fumed silica, stone, aggregate, and mixtures thereof. Moreover, the inorganic filler can be spherical, fibrous, plate-like, particulate, sheet-like or whisker-like in shape and can be optionally pretreated by a silane coupling agent. The amount of inorganic filler particles, if present, is preferably from about 10 wt. % to about 90 wt. %, from about 25 wt. % to about 80 wt. %, from about 35 wt. % to about 80 wt. %, from about 45 wt. % to about 80 wt. %, from about 55 wt. % to about 80 wt. %, from about 65 wt. % to about 80 wt. %, and preferably from about 75 to about 80 wt. % based on the weight of the composition to be applied.

Preferably, the inorganic filler particles have an average D50 particle diameter of from 0.10 mm to 2.0 mm and, preferably, from 0.145 mm to 0.70 mm. In some embodiments, the average D50 particle diameter is 0.004 mm. The average D50 particle diameter is the corresponding particle size when the cumulative percentage reaches 50% measured using sieve analysis. The shape of each of the inorganic particles is not particularly limited, and may be appropriately selected from a spherical shape, a substantially spherical shape, an amorphous shape, a needle shape, an aggregate shape, a cluster shape, and the like. It is generally preferred to use spherical or substantially spherical inorganic particles or powder obtained by aggregating the spherical or substantially spherical inorganic particles through heat treatment or the like.

In one embodiment, the liquid curable composition further comprises at least one glycol additive in the amount of 0.25-10% based on weight of the final composition. The liquid curable composition may include other optional components as necessary including, for example, pigments, plasticizers, dispersants, surfactants, thickeners, anti-aggregation agents, defoaming agents, dyes, polymerization inhibitors, antifungal agents, antioxidants, UV absorbers, and a pH adjusting agent. Preferably, the liquid curable composition is free of sealers, rubbers, and foaming agents. Such components if used are used at less than 5% of the composition by weight. Rheology modifiers include fumed silica, dispersant aids, and anti-settlement aids and can be added as well as the others optional components to provide the desired rheological or performance properties.

In another embodiment, disclosed is a method for establishing ballast protection film over a waterproofing membrane, the method comprising: a. providing at least one layer of a waterproofing membrane on a surface to form a waterproof seal upon said surface: b. mixing together at least two components, wherein one component comprises at least one reactive (meth)acrylate-based monomer and the other component comprises at least one polymerization initiator to activate polymerization of the reactive (meth)acrylate-based monomer and to form a liquid curable composition; and c. applying onto a surface of the waterproofing membrane the liquid curable composition at an average uncured thickness of at least about 0.5 mm, wherein the liquid curable composition comprises (i) from about 1 to about 20 wt. % of at least one reactive (meth)acrylate-based monomer: (ii) from about 1.0 to about 10 wt. % of a polymerization initiator added to activate polymerization of the reactive (meth)acrylate-based monomer, wherein the liquid curable composition cures and forms a resin film when applied to the surface of the waterproofing membrane; and (iii) from about 55 wt. % to about 80 wt. % of inorganic particles.

As mentioned above, the components are mixed together just prior to application of the ballast protection film. For example, a mixer can used for mixing the liquid curable composition. Exemplary liquid curable compositions as disclosed herein can be made, for example, using two or more components which are blended together and combined with inorganic particles to form the slurry composition, which may be shipped or otherwise transported to the construction site, where it is then applied onto the waterproofing membrane to form a ballast protection film or films. The liquid curable composition may, for example, be extruded in wet form through hose (and optionally a die or pipe) in any number of cross-sectional shapes, such as cylindrical, square, rectangular, or other cross-sectional shapes, onto the waterproofing membrane surface while the forming resin is malleable or shapable and is able to bond to the waterproofing membrane before hardening (curing). Preferably, the composition is applied by extrusion (such as by using pressurized hose or pipe having spray nozzle), but may also include application by a screed bar, brush, trowel, sponge, mop, or other modes for applying liquid coatings. As used herein, “extrusion” means that the two or three-component resin system is pumped using at a 98:2 or 1:1 or another desired ratio. The components are mixed in line and applied or extruded via a hose. The material which extrudes from the hose nozzle or spray tip is applied on to the substrate and cures within one hour. The curing of the material concludes the extrusion process. The application of the polymerizing liquid composition can be performed at ambient temperatures or the composition can be run through, for example, a heat exchanger to increase the temperature to increase the polymerization rate.

The ballast protection layer can be applied onto the substrate flat or stepped, in one application at typical thicknesses of at least about 50 mm. In some embodiments, the thickness of the layer as applied (uncured) is from about 0.5 mm to about 50 mm or more if required.

Once ballast protection layer is fully cured, no further sealer coats are required, and is ready to be trafficked or accept stone ballast.

The ballast protection layer can cure in less than one hour at a wide variety of temperatures, ranging from −20° C. to +50° C.

An example of a three-component liquid curable composition can be made as follows: a first component can be made wherein at least one polymerizable acrylic monomer is present at a concentration of 1-20%; a second component comprises an organic peroxide initiator present in an amount of no less than 0.5% and no greater than 10%; and a third component comprises typically the same monomer as the first component present at a concentration of 1-20%, all percentages based on weight. In this embodiment, the first component will typically contain an accelerator. The second and third components can be mixed on site to create an activated third component. When the activated third component and the first component are mixed, then the reaction starts. The mixing of the components can take place in a mechanical mixer or pump and extruded or sprayed.

An example of a two-component liquid curable composition includes a first component “A” containing a polymerizable acrylate monomer combined with a second component “B” having a free radical initiator, such that polymerization reaction leads to curing. Component A may further comprise, in addition to acrylate monomers, polymethylmethacrylic (“PMMA”) polymer, and other components such as an accelerator (e.g., dimethyl-p-toluidine, or “DMPT”).

On combination of the above-described components, specifically the acrylate-based components, the resulting material is fluid and readily applied onto the substrate (e.g., waterproofing membrane) at the appropriate thickness. The radical initiator and acrylate mixture form the basis of the reaction that leads to polymerization. The mixture is sprayed (or otherwise applied) onto the substrate before curing. Before cure takes place a screed bar can be used to form a flat or stepped trafficable coating layer due to the resins unique rheology, with no requirement for additional layers or sealers. Furthermore when the resin is cured it provides a wear and skid-resistant surface.

More broadly, using a railway deck as an exemplary application, a base layer or surface of a bridge deck is provided, a primer is applied onto the bridge deck substrate, one or more layers of waterproofing membranes are applied onto the primer, the ballast protection film of certain embodiments of the current invention is applied onto the waterproofing membrane, and optionally ballast is applied onto the ballast protection film.

In certain exemplary embodiments, the present invention teaches a liquid curable composition that has superior rheological properties and can be spray, extruded or hand applied to various coat weights or thicknesses. The resin has a wide application temperature range and can be cold applied using a single leg, a 1:1 or a 98:2 ratio pump. Once applied, the system cures seamlessly providing strong adhesion to the waterproofing membrane and a rough surface texture when the inorganic particles are used. The rheology is such that a stepped shape can be formed with a one layered application. Furthermore, the resulting cured coating provide a skid resistance to allow for low to medium traffic on the deck. The rough surface texture is formed due to the special rheology of the formulation. This is a unique property of the resin that it allows for aggregate to be homogenously mixed in without settling in the container. The exemplary embodiment has a cure time within two (2) hours, and preferably one (1) hour, from minus −20° C. to 50° C., is a 100% solids reactive system, and has low volatile organic content (VOC) when tested to the standard ASTM D2369 Method B with results <100 g/l. Shear and Tensile adhesion values of the exemplary embodiment to the membrane were found to be excellent (ETAG 033 standard). In certain embodiments, the composition is particularly useful with waterproofing membranes and can be applied under normal conditions experienced on concrete and steel bridge decks.

In some embodiments, the step of applying onto the installed membrane a slurry composition is applied at temperatures in the range of −20° C. and +50° C., the slurry composition having a cure window of no less than 20 minutes and no greater than 120 minutes. Within the context of the present disclosure, the term “cure time” refers to the time required for the fully initiated composition to solidify with a tack free surface. Cure time is recorded in any unit of time, such as seconds, minutes, or hours. Within the context of the present disclosure, unless otherwise stated, cure time is acquired according to ASTM D5895 standards and/or otherwise recorded when the material is dry to physical touch.

Within the context of the present disclosure, the term “cold-applied” refers to the ability of a composition to be applied at ambient temperature without use of boilers for melting or heated lines prior to application. The use of boilers or other heating means is undesirable due to the high energy requirements on site, the risks associated with manual handling of molten liquids and the potentially toxic fumes emitted during application. In contrast, embodiments of the current trafficable coating composition can be applied at a range of ambient temperatures (e.g., about −20° C. to about 50° C.) without any requirement for heating.

Within the context of the present disclosure, the term “screed bar or screed” can refer to various application techniques. After the resin is activated and extruded or poured on to the deck, the resin can be spread out using a variety of screeding techniques. For example, a large screed bar running the width of the deck can be used with mold strips on the sides to control thickness. Alternatively, pin bar rakes can be used which have adjustable heights of 1 mm to 20 mm. Pin rakes can have varying widths depending on the area that needs to be covered. For example, a 1-meter-wide pin rake set to 5 mm could be used for the central longitudinal strip of the deck and once fully cured the sides could be done. For the sides the pin rake could be set to a height of 2.5 mm. This would mean 3 meters of the deck would be covered, but if the deck is wider then a number of configurations and combinations could be employed to cover the deck. For very thin applications (<2 mm), for examples on the sides of the deck, a normal coating roller could also be employed. In addition to a pin rake and a roller, application could be done using flat or notched rubber squeegees of varying sizes and heights.

In an exemplary aspect, the shapes can be established in one or two extrusions, in contrast to prior art spray techniques wherein successive pluralities of spray passes were required to build up to a desired shape. In other words, the triangular cross-sectional shapes can be obtained in one extrusion using a triangular shaped die. A rectangular cross-sectional shape can be obtained in one extrusion through a slot die. A stepped cross-sectional shape can be obtained by extruding a narrower rectangle shape upon a wider rectangle shape; or alternatively by extruding a taller rectangle cross-sectional shape next to a shorter rectangle cross-sectional shape. The ability to extrude various shapes means that the ballast protection member or member units can be extruded in a “longitudinal” direction that would coincide, for example, with the direction of train rails on a railway bridge deck or the direction of vehicular travel on a highly bridge deck. Various shapes in cross-section can be achieved using a screed bar, a squeegee, an adjustable height pin rake and coating roller. Molds at various thicknesses can be used to attain the desired thickness.

In one embodiment, the cross-sectional stepped shape of the ballast protection layer is formed by extruding a flat shape to form a first layer having a first edge-to-edge width; and then extruding onto the first layer a second flat shape having a narrower edge-to-edge width.

In another embodiment, the cross-sectional stepped shape of the ballast protection layer is formed by extruding a taller square or rectangular shaped member next to a shorter square or rectangular shaped member.

Within the context of the present disclosure, the term “viscosity” or “slump” refers to the measure of a fluid's resistance to deformation (flow) at a given shear rate. A liquid with a lower viscosity flows more readily than a liquid with a higher viscosity. Viscosity is typically measured in units of centipoise (cP), however in this case a slump table may be used. The slump table is commonly used to measure the flow rate of mortars and other viscous products. In the case of the applied liquid curable compositions, the composition which has been conditioned to 23° C. is added to a hollow conical cylinder which sits on a circular metal flat table. The cone has a height of 25 mm and has an upper internal diameter of 90 mm and a lower internal diameter of 100 mm. Any excess slurry is scraped off the cone. The operator then gently pulls up the cone, scrapes the inside with a spatula to ensure all the slurry is on the table. Thus, the starting diameter of the slurry is 90 mm and depending on the flow properties of the slurry, the slurry will spread to a particular final diameter, which is measured after one minute. Thus, for example, if the spread after one minute is none (zero), i.e., the slurry diameter is still 90 mm, this would be 0% spread. The current invention is unique in that the rheology can be modified to adjust the flow to reach varying final flow diameters from 90 mm to 230 mm depending on the application requirements. In other words, from no flow to fully self-levelling.

Within the context of the present disclosure, the term “shear adhesion” refers to a measure of bond strength between two distinct materials, such as between a waterproofing membrane and the current invention, where the composite resists shear forces that cause the trafficable coat to slide off the substrate/membrane. Shear adhesion is typically recorded as units of megapascals (MPa) and may be determined by methods known in the art. Within the context of the present disclosure, shear adhesion measurements are acquired according to ETAG 033 standards, specifically EN13653:2004, unless otherwise stated. Preferably, the ballast protection film of the present disclosure has a shear adhesion of greater than 0.1 MPa and preferably over 1 MPa and more preferably over 2 MPa.

Within the context of the present disclosure, the term “tensile adhesion” refers to a measure of bond strength between distinct materials, more specifically between the concrete or steel, the primer, waterproofing membrane and the trafficable coat, upon applying a perpendicular tensile force. Tensile adhesion is typically recorded as units of megapascals (MPa) and may be determined by methods known in the art. Within the context of the present disclosure, tensile adhesion measurements are acquired according to ETAG 033 standards, specifically EN13596, unless otherwise stated. Preferably, the ballast protection film of the present disclosure has a tensile adhesion of greater than 0.1 MPa and preferably over 1 MPa and more preferably over 2 MPa.

Within the context of the present disclosure, the term “surface texture, macro texture or skid resistance” refers to a material property in which the trafficable coating provides a slip resistant surface. The rough surface is measured using a portable skid resistance tester such as the Pendulum Tester (BS EN 13036-4, ASTM E303). The Pendulum Skid Tester was originally designed in the 1940's in the US, the instrument was further developed in the 1960's at the UK Transport Research Laboratory for the testing of road surfaces. The Pendulum Tester measures the frictional resistance between a rubber slider mounted on the end of a pendulum arm and the test surface. This provides highway engineers with a routine method of checking the resistance of wet and dry surfaces to slipping and skidding, both in the lab and on site. It is based on the Izod principle: a pendulum rotates about a spindle attached to a vertical pillar. At the end of the tubular arm a head of known mass is fitted with a rubber slider. The pendulum is released from a horizontal position so that it strikes the sample surface with a constant velocity. The distance travelled by the head after striking the sample is determined by the friction of the sample surface. A reading of Skid Resistance is then obtained. Based on the UKSRG 2005 classification a test value of 0-24 has high slip potential, a value of 25-35 has moderate slip potential and a 36+ result has low slip potential.

In embodiments, the cured ballast protection film has a surface Skid Resistance Value of greater than 30, preferably a value closer to 90. Within the context of the present disclosure, the term “surface texture, macro texture or skid resistance” refers to a material property in which the trafficable coating provides a slip resistant surface. The rough surface is measured using a portable skid resistance tester such as the Pendulum Tester (BS EN 13036-4, ASTM E303).

Skid resistance can be measured by the Pendulum Skid Tester, which was originally designed in the 1940's in the US, the instrument was further developed in the 1960's at the UK Transport Research Laboratory for the testing of road surfaces. The Pendulum Tester measures the frictional resistance between a rubber slider mounted on the end of a pendulum arm and the test surface. This provides highway engineers with a routine method of checking the resistance of wet and dry surfaces to slipping and skidding, both in the lab and on site. It is based on the Izod principle: a pendulum rotates about a spindle attached to a vertical pillar. At the end of the tubular arm a head of known mass is fitted with a rubber slider. The pendulum is released from a horizontal position so that it strikes the sample surface with a constant velocity. The distance travelled by the head after striking the sample is determined by the friction of the sample surface. A reading of Skid Resistance is then obtained. Based on the UKSRG 2005 classification a test value of 0-24 has high slip potential, a value of 25-35 has moderate slip potential and a 36+result has low slip potential.

Embodiments of the current ballast protection film can be seen to exhibit excellent tunable rheological properties. Resins with higher viscosity or a narrow slump can be prepared for stepped-one-layer applications whereas lower viscosity or a wide slump can be prepared for one layered flat applications. The rheology can be modified with the use different peroxide initiators as it was found that adding peroxide suspension provided a narrower slump. In addition, additives such as mono propylene glycol or water can be added to the peroxide suspension on-site to further increase the viscosity and narrow the slump. Furthermore, exemplary skid resistance values were obtained from the one-layered amalgamated system. The mixing of aggregate or stone into the acrylate-based resin before application further increases skid resistance if required, for example for permanently exposed highway applications. While conventional reactive ballast coats or sheet systems can provide a ballast layer that protects the waterproofing membrane, they do not provide suitable skid resistance, simple amalgamated liquid application, wear resistance and the formation of a stepped structure in a one pass application.

Conventionally, ballast protection systems require a plurality of layers including a sealer coat and have no skid resistance properties. As such, it was surprising when embodiments of the present invention were found to provide a one layered flat or stepped coating without the requirement of a sealer. Furthermore, the current invention provides a rough surface texture allowing for excellent skid resistance and trafficability. Without being bound by theory, it is hypothesized that this phenomenon is occurring due to the combination of acrylate chemistry and a rheological agent such as, for example, fumed silica, which provide robustness and high modulus (excellent wear properties, therefore requiring no sealer), ease of application and surface texture.

Within the context of the present disclosure, the terms “robustness and high modulus” refer to the material having a defined set of physical properties such as rut resistance and retention of SRV after wheel tracking at 23° C. and 50° C. The initial SRV should be greater than 20 but preferred is >35 (BBA Guidelines doc Appendix A, method 1). After wheel tracking the SRV should be great than 20 but >35 is preferred as per BBA Guidelines document for Crack Sealing systems. A minimum 60 SRV is required for heavy highway traffic coatings that will be permanently exposed, however in railway applications only very light traffic will be expected during the construction phase only. After the construction phase and the ballast has been applied, the trafficable coating will not be trafficked. In highway applications the trafficable coating will be exposed to heavy traffic permanently. Furthermore, after wheel tracking at 50 and 60° C., the change in spread and thickness of the system should be minimal, i.e., less than 5% (BBA Guidelines doc Appendix A, method 2). The modulus of the cured coating should be above 200N, but it is preferred to be above 1000N (BBA Guidelines doc Appendix A, method 7) with the exception to the test method being that the modulus or stress value can be taken at any strain value. In one embodiment, the ballast protection layer has a modulus of no less than 200 Newtons (N), and more preferably no less than 500, and most preferably no less than 1000 N.

In one embodiment, the resulting ballast protection layer has a VOC of less than 100 g/l when tested to the standard ASTM D2369 Method B.

It should be noted that although the current composition and method are typically most beneficial for adhesion onto a waterproofing membrane and various types of ballast in railway bridge deck applications, other suitable covering materials instead of ballast and applications are contemplated herein as well.

### EXAMPLES

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total trafficable coat composition, unless otherwise specified.

### Example 1

An amalgamated trafficable coating was prepared according to the following formulation:
(1) Component (A) comprising:
   a. an acrylate resin in the amount of 30-50%
      The acrylate resin in component A comprises:
1) Acrylate monomers such as Methyl Methacrylate, n-Butyl Methacrylate and 2-Ethyl Hexyl Acrylate with an overall percentage of no less than 5% and no greater than 30%, and preferably 12.85%.
2) Polymethyl methacrylate Polymer percentage of no less than 0% and no greater than 15%, and preferably 5%.
3) Paraffin Bead Wax percentage of no less than 0% and no greater than 1%, and preferably 0.25%.
4) Polyurethane acrylate polymer percentage of no less than 0% and no greater than 40%, and preferably 3%.
5) Free radical inhibitors such as Hydroxy-Tempo or Hydroxy Quinone percentage of no less than 0% and no greater than 0.5%, and preferably 0.1%.
6) Dispersant aid such as Anti-Terra 204 or Solsperse 8000 percentage of no less than 0% and no greater than 0.5%, and preferably 0.1%.
7) Fumed Silica percentage of no less than 0% and no greater than 3%, and preferably 0.5%.
8) Plasticiser percentage of no less than 0% and no greater than 5%, and preferably 2%.
9) Accelerators such as Diisopropyl toluidine and Dimethl propyl toluidine percentage of no less than 0% and no greater than 1.5%, and preferably 0.5%.
10) Calcium Carbonate percentage of no less than 10% and no greater than 50%, and preferably 24% with a D50=0.004 mm. D50 is the corresponding particle size when the cumulative percentage reaches 50% measured using sieve analysis.
11) SP 30 Dry Sand percentage of no less than 0% and no greater than 25%, and preferably 11.3% with a D50=0.4 mm.
12) Redhill 110 Sand percentage of no less than 0% and no greater than 25%, and preferably 11.3% with a D50=0.145 mm.
13) Garside 16/30 Sand percentage of no less than 0% and no greater than 50%, and preferably 28% with a D50=0.7 mm.
(2) Component (B) comprising:
   a. an initiator suspension or powder, such as a peroxide initiator, in an amount of about 0-10% by weight of the composition
      The component B comprises:
1) Dibenzoyl Peroxide at 50%, and no less than 20% and no greater than 60%.
2) 50% of an organic plasticizer or phlegmatizer, and no less than 40% and no greater than 80%.
(3) Component (C) comprising:
   a. an acrylate resin in the amount of 30-50%
      The acrylate resin in component C comprises:
1) Acrylate monomers such as Methyl Methacrylate, n-Butyl Methacrylate and 2-Ethyl Hexyl Acrylate with an overall percentage of no less than 5% and no greater than 30%, and preferably 12.85%.
2) Polymethyl methacrylate Polymer percentage of no less than 0% and no greater than 15%, and preferably 5%.
3) Paraffin Bead Wax percentage of no less than 0% and no greater than 1%, and preferably 0.25%.
4) Polyurethane acrylate polymer percentage of no less than 0% and no greater than 40%, and preferably 3%.
5) Free radical inhibitors such as Hydroxy-Tempo or Hydroxy Quinone percentage of no less than 0% and no greater than 0.5%, and preferably 0.1%.
6) Dispersant aid such as Anti-Terra 204 or Solsperse 8000 percentage of no less than 0% and no greater than 0.5%, and preferably 0.1%.
7) Fumed Silica percentage of no less than 0% and no greater than 3%, and preferably 0.5%.
8) Plasticiser percentage of no less than 0% and no greater than 5%, and preferably 2%.
9) Calcium Carbonate percentage of no less than 10% and no greater than 50%, and preferably 24% with a D50=0.004 mm. D50 is the corresponding particle size when the cumulative percentage reaches 50% measured using sieve analysis.
10) SP 30 Dry Sand percentage of no less than 0% and no greater than 25%, and preferably 11.3% with a D50=0.4 mm.
11) Redhill 110 Sand percentage of no less than 0% and no greater than 25%, and preferably 11.3% with a D50-0.145 mm.
12) Garside 16/30 Sand percentage of no less than 0% and no greater than 50%, and preferably 28% with a D50=0.7 mm.
13) Dense Silica (Sibelite) at 20% and no less than 0% and no greater than 30%.
14) Glass beads (Spheriglass <0.5 mm) at 10% and no less than 0% and no greater than 30%.
15) Aggregate (1-3 mm) at 10% and no less than 0% and no greater than 30%.
16) Pigment at 0.5% range at no less than 0% and no greater than 3%.

Testing of Component A and Component C (non-activated) showed that the respective resins provided a slump measurement of 18 2 mm and 175 mm respectively (90 mm cone, 350 g sample, 25 bumps, no peroxide). It should be noted that a further change in slump can be observed depending on the type of Component B that is added (i.e., powder Vs suspension). In order to ascertain the gel time, the Component C was activated by mixing in 2% of Component B (peroxide powder) for 30 seconds. The activated Component C was then mixed with Component A in a 50:50 ratio at 23° C. resulting in a gel time of 12 minutes.

In order to prepare cured samples of the trafficable coating, Component C was activated with Component B and placed under the 1:1 ratio pump leg. Component A was placed under the adjacent leg and the combined material was extruded onto the substrate. The substrate comprised of the following materials: concrete paving slab, primer and waterproofing membrane. The trafficable coating was directly applied onto the waterproofing membrane.

Once the liquid trafficable coating was extruded onto the substrate at 23° C., immediately a stepped screed bar was used to obtain a thickness of 4 mm in the middle and 2 mm on the sides. The trafficable coating had fully cured in around 20 minutes at 23° C. In addition to preparing the trafficable coating sample, addition samples were prepared to test the physical properties and skid resistance. The physical properties of the cured trafficable coating indicated a stress value of 1400N at 10% strain ((BBA Guidelines doc Appendix A, method 7). An average skid resistance value of 45 was obtained.

The liquid trafficable coating exhibited excellent rheological properties as it was liquid and flowable before activation with peroxide and once activated, the slump was ideal for screeding using a stepped screed bar to form the desired shape. The gel time was relatively fast and the trafficable coating did not slump out of shape during the cure time. The fast gel time provides numerous advantages to customers including labor and time savings for follow on trades. Considering the slump of the material is ideal to form a stepped shape in one pass, it provides significant advantages over multi-layered systems from an application perspective. The physical properties of the cured system strongly indicate that the system is robust and durable. Due to the thixotropic behavior of the resin a rough surface texture was observed, resulting in a skid resistance value of 45, which is ideal for temporary trafficking. These performance characteristics and application methodology make the current invention unique in the railway and highway bridge deck field.

### Example 2

A amalgamated trafficable coating was prepared according to the following formulation:
(1) Component (A) comprising:
   a. an acrylate resin in the amount of 90-100%
      The acrylate resin in component A comprises of:
1) Acrylate monomers such as Methyl Methacrylate, n-Butyl Methacrylate and 2-Ethyl Hexyl Acrylate with an overall percentage of no less than 5% and no greater than 30%, and preferably 12.85%.
2) Polymethyl methacrylate Polymer percentage of no less than 0% and no greater than 15%, and preferably 5%.
3) Paraffin Bead Wax percentage of no less than 0% and no greater than 1%, and preferably 0.25%.
4) Polyurethane acrylate polymer percentage of no less than 0% and no greater than 40%, and preferably 3%.
5) Free radical inhibitors such as Hydroxy-Tempo or Hydroxy Quinone percentage of no less than 0% and no greater than 0.5%, and preferably 0.1%.
6) Dispersant aid such as Anti-Terra 204 or Solsperse 8000 percentage of no less than 0% and no greater than 0.5%, and preferably 0.1%.
7) Fumed Silica percentage of no less than 0% and no greater than 3%, and preferably 0.5%.
8) Plasticiser percentage of no less than 0% and no greater than 5%, and preferably 2%.
9) Accelerators such as Diisopropyl toluidine and Dimethl propyl toluidine percentage of no less than 0% and no greater than 1.5%, and preferably 0.5%.
10) Calcium Carbonate percentage of no less than 10% and no greater than 50%, and preferably 24% with a D50=0.004 mm. D50 is the corresponding particle size when the cumulative percentage reaches 50% measured using sieve analysis.
11) SP 30 Dry Sand percentage of no less than 0% and no greater than 25%, and preferably 11.3% with a D50=0.4 mm.
12) Redhill 110 Sand percentage of no less than 0% and no greater than 25%, and preferably 11.3% with a D50=0.145 mm.
13) Garside 16/30 Sand percentage of no less than 0% and no greater than 50%, and preferably 28% with a D50=0.7 mm.
14) Pigment at 0.5% range at no less than 0% and no greater than 3%.
(2) Component (B) comprising:
   a. an initiator suspension or powder, such as a peroxide initiator, in an amount of about 0-10% by weight of the composition
      The component B comprises of:
1) Dibenzoyl Peroxide at 50%, and no less than 20% and no greater than 60%.
2) 50% of an organic plasticizer or phlegmatizer, and no less than 40% and no greater than 80%.

Testing of Component A without any Component B provided a slump measurement of 210 mm respectively (90 mm cone, 350 g sample, 25 bumps, no peroxide). In order to ascertain the gel time, the Component A was mixed with the Component B at a weight ratio of 98:2 (98g sample, 2g peroxide powder) at 23° C. for 30 seconds. The resulting gel time was 8 minutes.

In order to prepare cured samples of the trafficable coating, Component A was mixed with Component B within a 98:2 ratio pump. The mixture was then extruded onto the substrate. The substrate comprised of the following materials: concrete paving slab, primer and waterproofing membrane. The trafficable coating was directly applied onto the waterproofing membrane. The waterproofing membrane in this case was washed with water and had a damp surface, but not wet. The surface would be deemed to be wet when a paper towel would get soaked with water. In the instance where the paper towel does not absorb visible water, the substrate is deemed as damp. It was found that the current invention cures and strongly adheres to even damp substrates, which is another remarkable feature of the system.

Once the liquid trafficable coating was extruded onto the substrate at 23° C., immediately a flat screed bar and molds were used to obtain a thickness of 4 mm in the middle strip of the substrate. After 20 minutes the middle strip had fully cured, after which two additional applications on each side of the strip took place using a sing mold and a flat screed bar to obtain a coating thickness of 2 mm. In order to spread out the resin on the substrate (4 mm strip and 2 mm strips) a pin rake with adjustable height was used. The trafficable coating had fully cured in around 20 minutes at 23° C. In addition to preparing the trafficable coating sample, addition samples were prepared to test the physical properties and skid resistance. The physical properties of the cured trafficable coating indicated a stress value of 1000N at 10% strain (BBA Guidelines doc Appendix A, method 7). An average skid resistance value of 45 was obtained.

The liquid trafficable coating exhibited excellent rheological properties as it was liquid and flowable before activation with BPO and once activated, the slump was ideal for screeding using a stepped screed bar to form the desired shape. Fast mixing and pump application was observed. The gel time was relatively fast allowing for additional applications to take place quickly. The fast gel time provides numerous advantages to customers including labor and time savings. The slump of the material allows for quick extrusion and spread ability on the deck which is advantageous over multi-layered, over scattered systems from an application perspective. The physical properties of the cured system strongly indicate that the system is robust and durable. Due to the thixotropic behavior of the resin a rough surface texture was observed, resulting in a skid resistance value of 45, which is ideal for temporary trafficking. These performance characteristics and application methodology make the current invention unique in the railway and highway bridge deck field.

The foregoing examples and embodiments were present for illustrative purposes only and not intended to limit the scope of the invention.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed:

1. A method for establishing ballast protection film over a waterproofing membrane, the method comprising:
a. providing at least one layer of a waterproofing membrane on a surface to form a waterproof seal upon said surface; and
b. applying onto a surface of the waterproofing membrane a liquid curable composition at an average uncured thickness of at least about 0.5 mm,
wherein the liquid curable composition comprises (i) at least one reactive (meth)acrylate-based monomer, and (ii) a polymerization initiator added to activate polymerization of the reactive (meth)acrylate-based monomer, wherein the liquid curable composition cures and forms a resin film when applied to the surface of the waterproofing membrane.

2. The method of claim 1 further comprising the step of adding a layer of ballast on top of the resin film.

3. The method of claim 1 or 2 wherein the liquid curable composition further comprises inorganic particles.

4. The method of claim 3 wherein the at least one reactive (meth)acrylate-based monomer is present in the liquid curable composition at from about 1 to about 40 wt. %, the polymerization initiator is present in the liquid curable composition at from about 1.0 wt. % to about 10 wt. %, and the inorganic particles are present in the liquid curable composition at from about 30 to 90 wt. %.

5. The method as in claim 3 or 4, in which the inorganic particles are selected from the group consisting of calcium carbonate, silicon oxide, fumed silica, stone, aggregate, and mixtures thereof.

6. The method as in claim 3, 4, or 5 wherein, in the step of applying onto the installed membrane a slurry composition, the inorganic particles have an average D50 particle size of from 0.01 mm and 4.0 mm, and the inorganic particles.

7. The method as is any one of claims 3-6 wherein the liquid curable composition containing the inorganic particles has a slump selected from the group consisting of from 90 to 230 mm and from 150-190 mm.

8. The method as in any one of the preceding claims wherein the liquid curable composition further comprises a polymerization accelerator.

9. The method of claim 8 wherein the polymerization accelerator is selected from the group consisting of diisopropyl toluidine, dimethyl propyl toluidine, trimethylamine, methyl hydroxy propyl toluidine, methyldimethanolamine, triethanolamine, p-diethylaminoacetophenone, p-dimethylaminoethylbenzoate, p-dimethylaminobenzoate-2-ethylhexyl, N,N-dimthylbenzylamine, and 4,4′-bis(diethylamino)benzophenone.

10. The method of claim 9 wherein the polymerization accelerator is selected from the group consisting of dimethyl propyl toluidine, diisopropyl toluidine, and methyl hydroxy propyl toluidine.

11. The method as in any one of the preceding claims wherein the at least one reactive (meth)acrylate-based monomer is selected from the group consisting of methyl methacrylate, butyl methacrylate, ethyl hexyl acrylate, hydroxy propyl methacrylate, and lauryl methacrylate.

12. The method of claim 11 wherein the at least one reactive (meth)acrylate-based monomer comprises methyl methacrylate.

13. The method as in any one of the preceding claims wherein the polymerization initiator is an organic peroxide.

14. The method of claim 13 wherein the polymerization initiator is dibenzoyl peroxide.

15. The method as in any one of the preceding claims wherein the applying step is accomplished by a extruding through at least one pump.

16. The method as in any one of the preceding claims wherein the liquid curable composition is applied onto the waterproofing membrane in at least two layers such that the ballast protection film has a cross-sectional stepped shape.

17. A method for establishing ballast protection film over a waterproofing membrane, the method comprising:
a. providing at least one layer of a waterproofing membrane on a surface to form a waterproof seal upon said surface;
b. mixing together at least two components, wherein one component comprises at least one reactive (meth)acrylate-based monomer and the other component comprises at least one polymerization initiator to activate polymerization of the reactive (meth)acrylate-based monomer and to form a liquid curable composition;
c. applying onto a surface of the waterproofing membrane the liquid curable composition at an average uncured thickness of at least about 0.5 mm, wherein the liquid curable composition comprises
(i) from about 1 to about 20 wt. % of at least one reactive (meth)acrylate-based monomer:
(ii) from about 1.0 to about 10 wt. % of a polymerization initiator added to activate polymerization of the reactive (meth)acrylate-based monomer, wherein the liquid curable composition cures and forms a resin film when applied to the surface of the waterproofing membrane; and
(iii) from about 55 wt. % to about 80 wt. % of inorganic particles.

18. The method of claim 17 further comprising the step of adding a layer of ballast on top of the resin film.

19. The method of claim 17 or 18 wherein the inorganic particles are selected from the group consisting of calcium carbonate, silicon oxide, fumed silica, stone, aggregate, and mixtures thereof.

20. The method of claim 19 wherein the inorganic particles are selected from the group consisting of calcium carbonate, aggregate, and silicon oxide, and mixtures thereof.

21. The method as in claim 19 or 20 wherein, in the step of applying onto the installed membrane a slurry composition, the inorganic particles have an average d50 particle size of from 0.01 mm and 4.0 mm, and the inorganic particles.

22. The method as in any one of claims 17-21 wherein the liquid curable composition further comprises from about 0.1 to about 5.0 wt. % of a polymerization accelerator.

23. The method of claim 22 wherein the polymerization accelerator is selected from the group consisting of diisopropyl toluidine, dimethyl propyl toluidine, trimethylamine, methyl hydroxy propyl toluidine, methyldimethanolamine, triethanolamine, p-diethylaminoacetophenone, p-dimethylaminoethylbenzoate, p-dimethylaminobenzoate-2-ethylhexyl, N,N-dimthylbenzylamine, and 4,4′-bis(diethylamino)benzophenone.

24. The method of claim 23 wherein the polymerization accelerator is selected from the group consisting of dimethyl propyl toluidine, diisopropyl toluidine, and methyl hydroxy propyl toluidine.

25. The method as in any one of claims 17-24 wherein the at least one reactive (meth)acrylate-based monomer is selected from the group consisting of methyl methacrylate, butyl methacrylate, ethyl hexyl acrylate, hydroxy propyl methacrylate, and lauryl methacrylate.

26. The method of claim 25 wherein the at least one reactive (meth)acrylate-based monomer comprises methyl methacrylate.

27. The method of as in any one of claims 17 to 26 wherein the polymerization initiator is an organic peroxide.

28. The method of claim 27 wherein the polymerization initiator is dibenzoyl peroxide.

29. The method as in any one of claims 17-28 wherein the applying step is accomplished by extruding through at least one pump.

30. The method as in any one of claims 17-29 wherein the liquid curable composition is applied onto the waterproofing membrane in at least two layers such that the ballast protection film has a cross-sectional stepped shape.

31. The method as in any one of claims 17-30 wherein the inorganic particles having an average D50 particle size of from about 0.5 mm to 3.0 mm.

32. The method as in any one of claims 1-16 wherein the inorganic particles having an average D50 particle size of from about 0.5 mm to 3.0 mm.

33. The method as in any one of the preceding claims wherein the thickness of the liquid curable composition uncured is from 0.5 mm to 50 mm.
